(19) United States
(12) Patent Application Publication
(10) Pub. No.: US 2005/0024260 A1
(43) Pub. Date: Feb. 3, 2005

(54) E-FIELD MONITOR FOR BROADBAND PULSED

(76) Inventor: Gary P. Johnston, Kent, WA (US)

Correspondence Address: HARNESS, DICKEY & PIERCE, P.L.C., P.O. BOX 828, BLOOMFIELD HILLS, MI, 48303, US

(21) Appl. No.: 10/630,252

(22) Filed: Jul. 30, 2003

(51) Int. Cl. G01S 7/40

(52) U.S. Cl. 342/173; 342/192; 342/175; 324/76.11; 324/76.19

(57) ABSTRACT

A system is provided for substantially continuously monitoring an electromagnetic intensity of short bursts of electromagnetic waves (E-waves) having frequencies within a broad frequency range. The system includes at least one antenna capable of detecting one or more bursts of E-waves and converting the bursts into radio frequency (RF) signals having an energy level correlated to the intensities of the E-waves. The system additionally includes at least one broadband equalizer that normalizes the energy levels of RF signals across the broad range of frequencies and at least one amplifier that amplifies the energy levels of the RF signals output by the broadband equalizer. The system further includes at least one RF peak power sensor for measuring the energy levels of the RF signals output from the amplifier and determining the peak power level of at least one peak RF signal that has the highest energy level. Further yet, the system includes at least one power meter that converts the peak power level of the peak RF signal to power units and a computer based device that utilizes the power units output by the peak power measurement subsystem to determine the strength of the E-wave correlated with the peak RF signal.

### STATEMENT OF GOVERNMENT RIGHTS

This invention was developed at least in part pursuant to Contract No. F04701-97-C-0004, with the U.S Air Force. The U.S. Government has certain rights in this invention.

### FIELD OF THE INVENTION

The present invention relates to narrow pulsed electromagnetic fields, or waves, generated by high power radio frequency (RF) emitters, such as radars. More specifically, the invention relates to a system for detecting the presence of such electromagnetic fields near electronic equipment that is vulnerable to anomalies causes by the electromagnetic fields.

### BACKGROUND OF THE INVENTION

High power emitters, such as radars, emit narrow pulsed electromagnetic fields (E-fields), also referred to in the art as electromagnetic waves (E-waves), over a very broad frequency range. These E-fields can potentially cause electronic interference with and/or corruption of electronic equipment exposed to the E-fields. More specifically, the greater the intensity of the E-fields, the greater the potential to cause interference and/or corruption of exposed electronic equipment. It is therefore highly desirable to know when E-fields occur so that diagnosis of anomalies in exposed electronic equipment can include E-field interference as a possible cause or contributor of the anomaly. Known systems, of moderate complexity and expense, for detecting E-fields generally can not continuously capture and measure all narrow pulsed radar emissions, e.g. pulses having a duration of equal to or greater than 300 nsec, over a broad frequency range, e.g. 1 to 10 GHz. For example, some known systems can only sample the E-field environment and consequently miss many radar pulses and/or they are unable to adequately detect narrow radar pulses over a broad frequency range.

Therefore, it is desirable to detect, measure and record the occurrence and strength of single or multiple narrow pulsed E-fields having frequencies anywhere within a very broad frequency range.

### SUMMARY OF THE INVENTION

In one preferred embodiment of the present invention a system is provided for substantially continuously monitoring the electromagnetic intensity of short bursts of electromagnetic waves (E-waves) having frequencies within a very broad frequency range. The system includes at least one antenna capable of detecting one or more bursts of E-waves and converting the bursts into radio frequency (RF) signals having an energy level correlated to the intensities of the E-waves. The system additionally includes at least one broadband equalizer that normalizes the energy levels of RF signals across the broad range of frequencies. The system further includes at least one amplifier that amplifies the energy levels of the RF signals output by the broadband equalizer. Further yet, the system includes at least one RF peak power sensor for measuring the energy levels of the RF signals output from the amplifier and determining the peak power level of at least one peak RF signal that has the highest energy level. Still further, the system includes at least one power meter that converts the output of peak power sensor into power units. The power meter communicates the power measurements to a computer based device that converts the power measurements to E-wave energy units that indicate the strength of the E-wave correlated with the peak RF signal. If the strength of the E-wave exceeds a predetermined limit, the time and strength of the E-wave is recorded by the computer based device.

In another preferred embodiment of the present invention a method is provided for substantially continuously monitoring the electromagnetic strength of narrow pulsed electromagnetic fields within a very broad frequency bandwidth. The method includes substantially continuously sensing one or more E-fields within a broad range of frequencies utilizing at least one antenna capable of receiving E-fields. The method additionally includes converting the E-fields into RF signals having energy levels correlated to strengths of the E-fields. Furthermore, the method includes determining the peak power level of at least one peak RF signal having the highest energy level utilizing at least one peak power measurement subsystem. The peak power level of the peak RF signal is then converted to power units utilizing the peak power measurement subsystem. The method further includes calculating the intensity of the E-field correlated with the peak RF signal based on the power units output by the peak power measurement subsystem. Any E-field intensity exceeding a predetermined level is the time tagged and recorded by the computer based device.

Further areas of applicability of the present invention will become apparent from the detailed description provided hereinafter. It should be understood that the detailed description and specific examples are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of an E-field monitoring system, in accordance with a preferred embodiment of the present invention;

FIG. 2 is a block diagram of a preferred alternate embodiment of the system shown in FIG. 1;

FIG. 3 is a block diagram of another preferred alternate embodiment of the system shown in FIG. 1; and

FIG. 4 is a flow chart of a method for monitoring E-fields utilizing the system shown in FIG. 1.

### DETAILED DESCRIPTION OF THE INVENTION

The description of the invention below is merely exemplary in nature and, thus, variations that do not depart from the gist of the invention are intended to be within the scope of the invention. Such variations are not to be regarded as a departure from the spirit and scope of the invention.

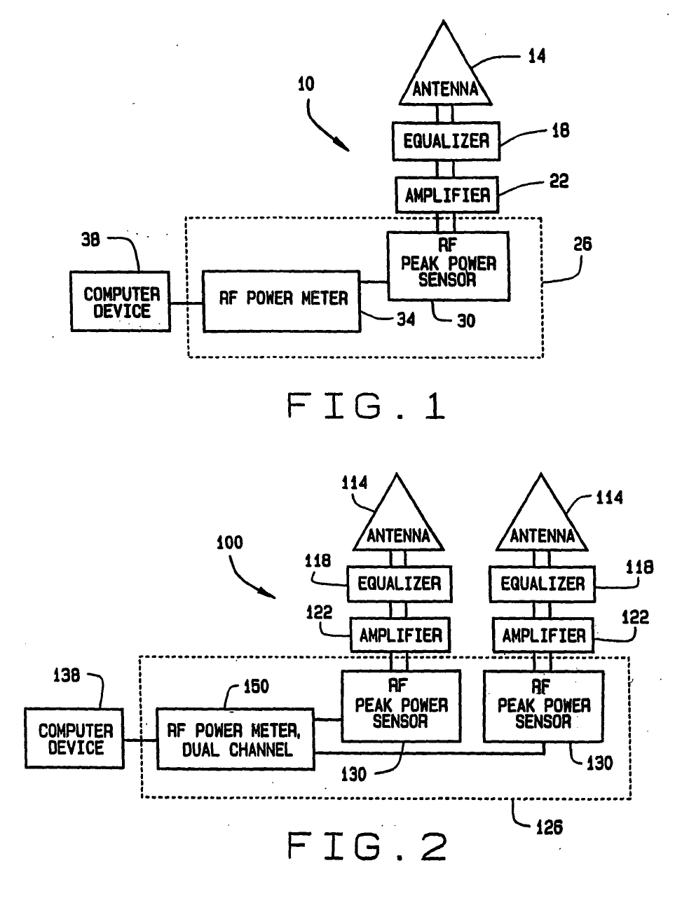

FIG. 1 is a block diagram of an E-field monitoring system 10, in accordance with a preferred embodiment of the present invention. The system 10 includes an antenna 14 that detects one or more E-fields and converts the E-fields into radio frequency (RF) signals. The antenna 14 is capable of sensing E-fields having frequencies within a very broad frequency range, for example 1 to 10 GHz. Preferably, the antenna 14 is an omni-directional antenna, however, antenna 14 can be any antenna suitable for receiving narrow pulsed E-fields with a broad frequency range. For example, antenna 14 can be a uni-directional antenna if it is desirable to sense E-fields from only one direction. Additionally, the antenna 14 can be selected to sense any polarization of E-fields, e.g. linear, circular or elliptical, based on the specific application of system 10. Thus, the choice of antenna 14 depends on the direction and polarization of the E-fields desired to be monitored and can be changed to suit any specific application.

The E-fields are received by the antenna 14 that converts the E-fields to RF signals having energy levels that correspond to the intensity/strength of the E-fields. However, the aperture of the antenna 14 decreases as the frequency of the E-fields increase, resulting in reduced output energy levels of the higher frequency E-fields received by the antenna 14. That is, as the frequencies of the E-fields increase the antenna 14 has less ability to convert the E-field intensity/strength into an RF signal energy level. For example, if the antenna 14 senses two E-fields having the same intensity, but one E-field has a frequency of 1 GHz and the other E-field has a frequency of 10 GHz, the RF signal output by the antenna 14 relating to the 10 GHz E-field will have a lesser energy level than the RF signal output by the antenna 14 relating to the 1 GHz E-field.

To compensate for the reduction of the energy levels due to the decreasing aperture of antenna 14 with increasing frequencies, the antenna 14 outputs the RF signals to a broadband RF equalizer 18. The equalizer 18 normalizes the energy levels over all frequencies of the RF signals output by the antenna 14. More specifically, since the antenna 14 will not convert as much E-field intensity into an RF signal energy level at higher frequencies, due to the decreasing aperture, the equalizer 18 compensates for the loss of energy output from the antenna as the frequencies increase. Therefore, elaborating on the example above, the equalizer 18 will normalize the RF signals output by the antenna 14 such that an RF signal output by the equalizer 18 relating to 1 GHz E-field will have the same energy level as an RF signal output by the equalizer 18 relating to the 10 GHz E-field. Furthermore, the equalizer 18 can contain compensation for frequency response variations in the amplifier 22, the RF peak power sensor 30, and the interconnections, e.g. coaxial cables, between the antenna 14, the equalizer 18, the amplifier 22 and the RF peak power sensor 30.

The system 10 further includes an amplifier 22 and a peak power measurement subsystem 26. The RF signals output by the broadband equalizer 18 are amplified by the amplifier 22 to a level compatible with the peak power measurement subsystem 26. Thus, the amplifier 22 enables the monitoring system 10 to detect and monitor very weak to very strong E-fields. The peak power measurement subsystem 26 is capable of measuring RF signals having very short durations. The peak power measurement subsystem 26 measures the energy levels of the RF signals output by the amplifier 22 and determines a peak power level of at least one peak RF signal having a maximum energy level, i.e. the highest energy level. The peak power measurement subsystem 26 then converts the peak power level of the peak RF signal to power units. e.g. Watts.

The peak power measurement subsystem 26 then communicates the power value of the peak RF signal to a computer based device 38, where the power value is converted, via calculations, to an E-field energy intensity/strength measurement that correlates to the peak RF signal, e.g. Volts/meter. The computer based device 38 then determines whether the E-field intensity exceeds a predetermined level. The predetermined level is settable via the computer based device 38 and relates to a maximum level of E-field energy that is desired to be allowed within a particular environment where electronic equipment is being used. That is, E-fields having intensities less than the maximum level are thought to have little or no potential for causing interference and/or corruption of electronic equipment exposed to the E-fields. E-fields having intensities that exceed the maximum level are recorded and stored via the computer based device for future retrieval and/or reference. Alternatively, the intensities of some or all the E-fields sensed by the antenna 14 can be time tagged, recorded and stored, and the E-field intensities that exceed the maximum level can be flagged.

The peak power measurement subsystem 26 can communicate with the computer based device 38 via a direct connection, i.e. hardwired, or via a wireless connection, e.g. infrared, wireless modem, or other wireless means. The computer based device 38 can be any device that generally includes a processor and memory suitable for executing software suitable for performing the necessary calculations for converting RF power into an E-field intensity/strength level. For example, the computer based device 38 can be a desktop computer, a laptop computer or a hand held computing device. In one preferred embodiment, the peak power measurement subsystem 26 includes a RF peak power sensor 30 and an RF power meter 34. The RF peak power sensor 30 measures the energy levels of the RF signals output from the amplifier 22 and determines the peak power level of the peak RF signal accordingly. The peak RF signal is output to the RF power meter 34 where the peak power level of the peak RF signal is converted to power units such as Watts.

It is envisioned that the monitoring system 10 can be either a stationary system or a portable system. For example, the monitoring system 10 could a stationary system wherein the antenna 14 is fixed to a stationary base and the broadband equalizer 18, the amplifier 22, the peak power measurement subsystem 26 and the computer based device 38 are placed on a substantially stationary fixture, such as an equipment rack. Conversely, the antenna 14 could be mounted to a movable cart and the broadband equalizer 18, the amplifier 22, the peak power measurement subsystem 26 and the computer based device 38 could be placed on shelves of the movable cart. Thus, the monitoring system would be portable such that it could be utilized to detect and monitor E-fields at various locations within any environment.

FIG. 2 is a block diagram of a preferred alternate embodiment of the E-field monitoring system 10, shown in FIG. 1. For clarity, the E-field monitoring system shown in this alternate embodiment will be referred to herein as monitoring system 100. Additionally, for clarity, all components in FIG. 2 that are identical to components in FIG. 1 will be identified in FIG. 2 using the reference numbers shown in FIG. 1 increased by one hundred. The monitoring system 100 includes two antennas 114 to increase the number and character of E-fields that the monitoring system 100 can sense. Accordingly, the monitoring system 100 also includes two broadband equalizers 118 to normalize the RF signals output by the antennas 114 and two amplifiers 122 to amplify the RF signals output by the broadband equalizers 118. It should be understood that the antennas 114, the equalizers 118 and the amplifiers 112 are identical in form and function as the antenna 14, the equalizer 18 and the amplifier 12 described above in reference to FIG. 1.

In one preferred embodiment, the peak power measurement subsystem 126 includes two RF peak power sensors 130. Each of the RF peak power sensors 130 is identical in form and function to the RF peak power sensor 30 described above in reference to FIG. 1. Thus, each RF peak power sensor 130 measures the energy levels of the RF signals output from the respective amplifiers 122 and determines a peak power level of a peak RF signal that correlates to an E-field detected by each of the respective antennas 114. Additionally, the peak power measurement subsystem 126 includes a dual channel power meter 150 that receives the peak RF signals from each of the RF peak power sensors 130. The dual channel power meter 150 converts the peak power levels of each of the peak RF signals to power units, e.g. Watts. These values are then output to the computer based device 138, which is identical in form and function as the computer based device 38 described above in reference to FIG. 1. In one preferred embodiment the antennas 114 are two circular polarized, hemispherical antennas. For example, one antenna 114 is a left hand circular polarized hemispherical antenna and the other antenna 114 is a right hand circular polarized hemispherical antenna. Therefore, the monitoring system 100 would be capable of sensing all polarizations or E-fields in a hemisphere. However, any combination of antenna polarizations can be selected depending on the specific application.

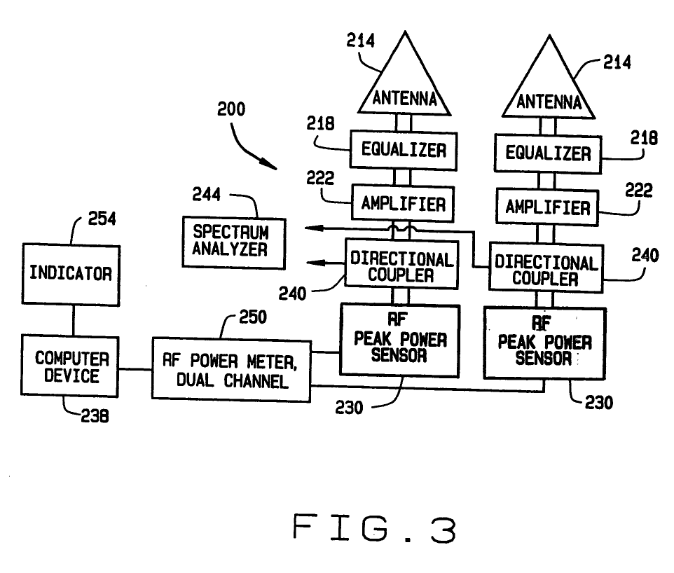

FIG. 3 is a block diagram of another preferred alternate embodiment of the E-field monitoring system 10, shown in FIG. 1. For clarity, the E-field monitoring system shown in this alternate embodiment will be referred to herein as monitoring system 200. Additionally, for clarity, all components in FIG. 3 that are identical to components in FIG. 1 will be identified in FIG. 3 using the reference numbers shown in FIG. 1 increased by two hundred. As in the monitoring system 100, shown if FIG. 2, the monitoring system 200 includes two antennas 214 to increase the number and character of E-fields that the monitoring system 200 can sense. Accordingly, the monitoring system 200 also includes two broadband equalizers 218 to normalize the RF signals output by the antennas 214 and two amplifiers 222 to amplify the RF signals output by the broadband equalizers 218. It should be understood that the antennas 214, the equalizers 218 and the amplifiers 212 are identical in form and function as the antenna 14, the equalizer 18 and the amplifier 12 described above in reference to FIG. 1.

The output of each amplifier 222 is passed through a directional coupler 240. The directional couplers 240 split the RF signals output from the respective amplifiers 222 into a first portion and a second portion. The first portion is output to RF peak power sensors 230. Each of the RF peak power sensors 230 are identical in form and function to the RF peak power sensor 30 described above in reference to FIG. 1. Each of the RF peak power sensors 230 is capable of measuring RF signals having very short durations. Thus, each peak power sensor 230 measures the energy levels of the RF signal first portions output from the respective directional couplers 240 and determines a peak power level of a peak RF signal that correlates to an E-field detected by each of the respective antennas 214. In one preferred embodiment, the second portions are output to at least one spectrum analyzer 244 that provides frequency measurements for each of the RF signals output from the amplifier 222.

A dual channel power meter 250 receives the peak RF signals output from each of the RF peak power sensors 230 and converts the peak power levels of each of the peak RF signals to power units, e.g. Watts. As with the RF peak power sensors 230, the power meter 250 is also capable of measuring RF signals having very short durations. These values are then output to the computer based device 238, which is identical in form and function as the computer based device 38 described above in reference to FIG. 1. In another preferred embodiment the monitoring system 200 includes an indicator 254 that is in communication with the computer based device 238. The indicator 254 can be included in the computer based device 238, directly coupled to the computer based device 238 or wirelessly linked to the computer based device 238. The computer based device 238 activates the indicator 254 when the intensity of an E-field correlated to a peak RF signal exceeds the predetermined level. The indicator 254 can be any device or method suitable for indicating that the predetermined level has been exceeded. For example the indicator 254 can be an LED display connected to the computer based device 238, a pop-up message that is displayed on the computer based device 238, or an audible indication sounded by the computer based device. In another embodiment the computer based device 238 can be used to control the operation of the RF power meter 250. For example, the computer based device 238 can make time dependent changes to the setting of the RF power meter 250 to better measure E-field intensities/strengths that may vary with time.

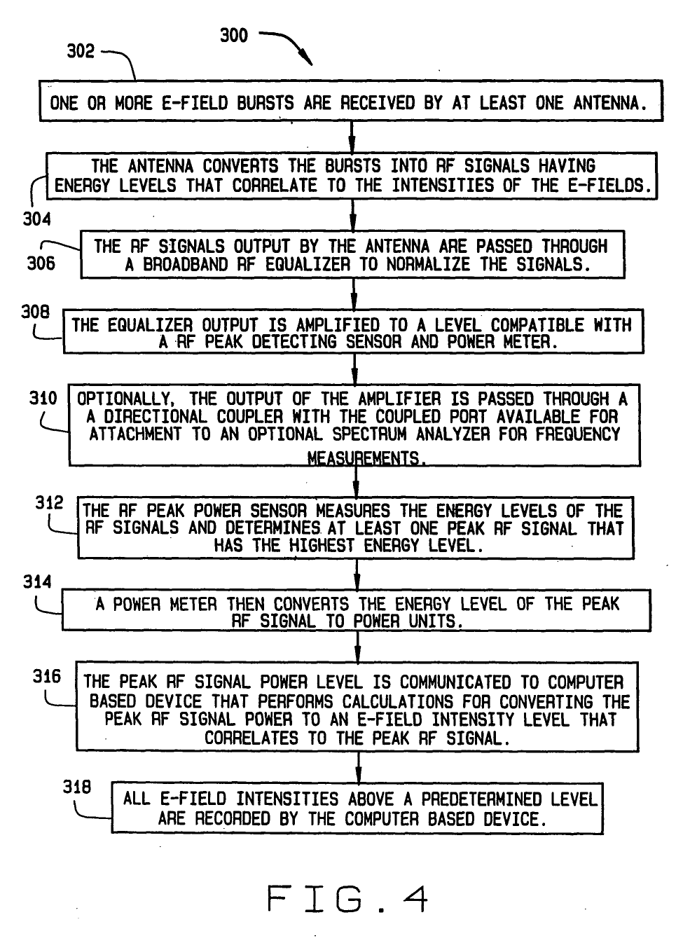

FIG. 4 is a flow chart 300 of a method for monitoring E-fields utilizing the system 10 shown in FIG. 1. One or more E-field bursts are received by at least one antenna, as indicated at step 302. The antenna converts the bursts into RF signals having energy levels that correlate to the intensities of the E-fields, as indicated at step 304. The RF signals output by the antenna are passed through a broadband RF equalizer to normalize the signals to compensate for the decreasing antenna aperture with increasing frequency, as indicated at step 306. The equalizer outputs are amplified to a level compatible with a RF peak power sensor and a power meter, as indicated at step 308. Optionally, the output of the amplifier is passed through a directional coupler with the coupled port available for attachment to an optional spectrum analyzer for frequency measurements, as indicated at step 310. The RF peak power sensor measures the energy levels of the RF signals and determines the peak power level of at least one peak RF signal that has the maximum energy level, i.e. highest energy level, as indicated at step 312. A power meter then converts the peak power level of the peak RF signal to power units, such as Watts, as indicated at step 314. The peak RF signal power level is communicated to a computer based device that performs calculations for converting the peak RF signal power into an E-field intensity level that correlates to the peak RF signal, as indicated at step 316. All E-field intensities above a predetermined level are recorded and stored by the computer based device, as indicated at step 318.

Generally, each combination of antenna, equalizer, amplifier and RF peak power sensor can be referred to as a channel. Although preferred embodiments of the monitoring system 10 have been illustrated and describe above to include one or two channels, it is envisioned that any number of channels can be employed and remain within the scope of the invention.

Thus, the E-field monitoring system described herein provides a system and method for substantially continuously detecting, measuring and recording the occurrence and strength of single or multiple narrow pulsed E-fields having frequencies anywhere within a very broad frequency range. Such information is very useful in diagnosing anomalies in electronic equipment that is susceptible to corruption due to exposure to E-fields produced by high power RF emitters such as radars.

While the invention has been described in terms of various specific embodiments, those skilled in the art will recognize that the invention can be practiced with modification within the spirit and scope of the claims.

1. A system for substantially continuously monitoring a strength of narrow pulsed electromagnetic fields, said system comprising:
at least one antenna adapted to detect one or more electromagnetic fields (E-fields) within a range of frequencies and convert the E-fields into radio frequency (RF) signals having energy levels correlated to strengths of the E-fields;
at least one peak power measurement subsystem adapted to determine a peak power level of at least one peak RF signal having a maximum energy level and convert the peak power level to power units; and
a computer based device adapted to utilize the power units output by the peak power measurement subsystem to determine the strength of the E-field correlated with the peak RF signal.

2. The system of claim 1, wherein the system further comprises at least one broadband equalizer adapted to normalize the energy levels of RF signals output from the antenna across the broad range of frequencies.

3. The system of claim 2, wherein the system further comprises at least one amplifier adapted to amplify the energy levels of the RF signals output by the broadband equalizer and output the amplified signals to the peak power measurement subsystem.

4. The system of claim 3, wherein the peak power measurement subsystem comprises at least one RF peak power sensor adapted to measure the energy levels of the RF signals output from the amplifier across a broad range of frequencies and determine the peak power level of the peak RF signal.

5. The system of claim 4, wherein the peak power measurement subsystem further comprises at least one power meter adapted to convert the peak power level of the peak RF signal to power units.

6. The system of claim 3, wherein the system further comprises at least one directional coupler adapted to divide each RF signal output by the amplifier into a first portion and second portion and output the first portions to the peak power measurement subsystem.

7. The system of claim 6, wherein the system further comprises at least one spectrum analyzer adapted to receive the second portions from the directional coupler and provide a frequency reading for each RF signal output by the amplifier.

8. The system of claim 1, wherein the peak power measurement subsystem is further adapted to measure RF signals across a broad range of frequencies.

9. The system of claim 1, wherein the antenna is an omni-directional antenna.

10. The system of claim 1, wherein the antenna is a uni-directional antenna.

11. The system of claim 1, wherein the computer based device is further adapted to:
determine whether the E-field strength correlated to the peak RF signal exceeds a predetermined level; and
record data pertaining to the peak RF signal when the peak RF signal exceed the predetermined level.

12. The system of claim 11, wherein the system further comprises an indicator in communication with the computer device, wherein the computer device is further adapted to activate the indicator when the strength of the E-field correlated the peak RF signal exceeds the predetermined level.

13. The system of claim 1, wherein the system includes two circularly polarized hemispherical antennas adapted to detect one or more E-fields within a broad range of frequencies and convert the E-fields into RF signals having energy levels correlated to strengths of the E-fields.

14. A method for substantially continuously monitoring a strength of narrow pulsed electromagnetic fields, said method comprising:
substantially continuously detecting one or more electromagnetic fields (E-fields) within a range of frequencies utilizing at least one antenna adapted to receive E-fields;
converting the E-fields into radio frequency (RF) signals having energy levels correlated to strengths of the E-fields utilizing the antenna;
determining a peak power level of at least one peak RF signal having a maximum energy level utilizing at least one peak power measurement subsystem;
converting the peak power level of the peak RF signal to power units utilizing the peak power measurement subsystem;
calculating the strength of the E-field correlated with the peak RF signal based on the power units output by the peak power measurement subsystem utilizing a computer based device.

15. The method of claim 14, wherein the method further comprises normalizing the energy levels of RF signals output from the antenna across the broad range of frequencies utilizing at least one broadband equalizer.

16. The method of claim 15, wherein the method further comprises:
amplifying the energy levels of the RF signals output by the broadband equalizer utilizing at least one amplifier; and
outputting the amplified signals to the peak power measurement subsystem.

17. The method of claim 16, wherein determining a peak power level of at least one peak RF signal comprises measuring the energy levels of the RF signals output from the amplifier across a broad range of frequencies utilizing at least one RF peak power sensor included in the peak power measurement subsystem; and
determining the peak power level of the peak RF signal utilizing the RF peak power sensor.

18. The method of claim 17, wherein converting the peak power level to power units comprises converting the peak power level of the peak RF signal to power units utilizing at least one power meter included in the peak power measurement subsystem.

19. The method of claim 16, wherein the method further comprises:
dividing each RF signal output from the amplifier into a first portion and second portion utilizing at least one directional coupler; and
outputting the first portions to the peak power measurement subsystem.

20. The method of claim 19, wherein the method further comprises:
outputting the second portions to at least one spectrum analyzer; and
providing a frequency reading for each RF signal output from the amplifier utilizing the spectrum analyzer.

21. The method of claim 14, wherein substantially continuously detecting one or more E-fields comprises at least one of:
substantially continuously detecting one or more E-fields utilizing an omni-directional antenna; and
substantially continuously detecting one or more E-fields utilizing a uni-directional antenna.

22. The method of claim 14, wherein the method further comprises:
determining whether the E-field strength correlated to the peak RF signal exceeds a predetermined level utilizing the computer based device; and
recording data pertaining to the peak RF signal when the peak RF signal exceeds the predetermined level.

23. The method of claim 22, wherein the method further comprises activating an indicator, in communication with the computer device, when the strength of the E-field correlated the peak RF signal exceeds the predetermined level.

24. A system for substantially continuously monitoring an electromagnetic intensity of short bursts of electromagnetic waves (E-waves) having frequencies within a broad frequency range, said system comprising:
at least one antenna adapted to detect one or more bursts of E-waves and convert the bursts into radio frequency (RF) signals having energy levels correlated to the intensities of the E-waves;
at least one broadband equalizer adapted to normalize the energy levels of RF signals across the broad range of frequencies;
at least one amplifier adapted to amplify the energy levels of the RF signals output by the broadband equalizer;
at least one RF peak power sensor adapted to measure the energy levels of the RF signals output from the amplifier and determine a peak power level of at least one peak RF signal that has the highest energy level;
at least one power meter adapted convert the peak power level of the peak RF signal to power units; and
a computer based device adapted to utilize the power units output by the peak power measurement subsystem to determine the strength of the E-wave correlated with the peak RF signal.

25. The system of claim 24, wherein the system further comprises at least one directional coupler adapted to divide each RF signal output by the amplifier into a first portion and second portion and output the first portions to the RF peak power sensor.

26. The system of claim 25, wherein the system further comprises at least one spectrum analyzer adapted to receive the second portions from the directional coupler and provide a frequency reading for each RF signal output from the amplifier.

27. The system of claim 24, wherein the antenna is an omni-directional antenna.

28. The system of claim 24, wherein the antenna is a uni-directional antenna.

29. The system of claim 24, wherein the computer based device is further adapted to determine whether the E-wave intensity correlated to the peak RF signal exceeds a predetermined level.

30. The system of claim 29, wherein the system further comprises an indicator in communication with the computer device, wherein the computer device is further adapted to activate the indicator when the intensity of the E-wave correlated to the peak RF signal exceeds the predetermined level.

31. The system of claim 24, wherein the system includes two circularly polarized hemispherical antennas adapted to detect one or more E-fields within a broad range of frequencies and convert the E-fields into RF signals having energy levels correlated to strengths of the E-fields.
